(19) United States
(12) Patent Application Publication
(10) Pub. No.: US 2021/0382491 A1
(43) Pub. Date: Dec. 9, 2021

(54) SELF-PROPELLED INSPECTION ROBOT

(71) Applicant: Hitachi, Ltd., Tokyo (JP)

(72) Inventors: Kazuya MUROTANI, Tokyo (JP); Noriyasu HASEJIMA, Tokyo (JP); Takehito OGATA, Tokyo (JP); Yuichi IGARASHI, Tokyo (JP); Kazuo ONO, Tokyo (JP); Yuta ESAKA, Tokyo (JP)

(21) Appl. No.: 17/245,041

(22) Filed: Apr. 30, 2021

(30) Foreign Application Priority Data
Jun. 9, 2020 (JP) 2020-100001

(51) Int. Cl. G05D 1/02; G05D 1/00

(52) U.S. Cl. CPC G05D 1/0214; G05D 1/0217; G05D 2201/0207; G05D 1/0061; G05D 1/0238

(57) ABSTRACT

A self-propelled inspection robot according to the invention includes a self-position estimation unit that performs inspection of an equipment by traveling on a travel route and obtains the position of the self-propelled inspection robot, an obstacle detection unit that detects an obstacle, an inspection continuity determination unit that determines whether the self-propelled inspection robot can continue the inspection, a mode selection unit that selects an automatic mode and a manual mode as a travel mode of the self-propelled inspection robot when the inspection continuity determination unit determines that the inspection cannot be continued, and a control unit that makes the self-propelled inspection robot automatically travel when the inspection continuity determination unit and when the mode selection unit selects the automatic mode, and makes the self-propelled inspection robot travel by a user's operation when the mode selection unit selects the manual mode.

### CLAIM OF PRIORITY

The present application claims priority from Japanese Patent Application JP 2020-100001 filed on Jun. 9, 2020, the content of which is hereby incorporated by reference into this application.

### BACKGROUND OF THE INVENTION

### 1. Field of the Invention

The present invention relates to a self-propelled inspection robot that inspects an equipment while autonomously traveling on a predetermined route.

### 2. Description of the Related Art

The self-propelled robot can perform work such as inspection on an equipment while autonomously traveling on a predetermined route. A technique is known in which a self-propelled robot generates an avoidance route or a detour route and continues traveling when it cannot travel on a predetermined route due to an obstacle or the like.

For example, JP 2018-99112 A discloses a travel route management system that determines a travel route of a work vehicle (self-propelled robot) that automatically travels while working. There is described a technique in which a work target area is divided to generate a plurality of travel route elements, a travel route element covering the work target area is selected based on a predetermined rule, and when an obstacle is detected, a travel route is generated to avoid the obstacle.

Further, in JP 2008-65755 A, there is described a technique in which, when a collision between a moving device (self-propelled robot) and an obstacle is predicted, a waypoint for avoiding the obstacle and one or more avoidance routes passing through the waypoint are calculated, so that an appropriate avoidance route is generated.

### SUMMARY OF THE INVENTION

In conventional techniques such as the techniques described in JP 2018-99112 A and JP 2008-65755 A, when an obstacle obstructs the traveling of the self-propelled robot, the robot continues to travel by following an automatically generated avoidance route. However, the detection accuracy of the obstacle is poor due to adverse conditions such as rain and fog, and it may be difficult to continue traveling automatically. Further, depending on the size and position of the obstacle, it may not be possible to generate an avoidance route that allows the robot to travel safely and automatically. In such a case, the self-propelled inspection robot that inspects the equipment cannot automatically continue the inspection and cannot carry out the inspection as planned, so that there is a problem that the inspection results cannot be sufficiently collected.

An object of the invention is to provide a self-propelled inspection robot capable of continuing an inspection even when the robot cannot travel on a predetermined travel route for inspection due to an obstacle.

The self-propelled inspection robot according to the invention is a self-propelled inspection robot for inspecting equipment by traveling on a predetermined travel route. The self-propelled inspection robot includes a self-position estimation unit that obtains a position of the self-propelled inspection robot, an obstacle detection unit that detects an obstacle around the self-propelled inspection robot, an inspection continuity determination unit that determines whether the self-propelled inspection robot can continue the inspection based on a position of the self-propelled inspection robot obtained by at least the self-position estimation unit and information of the obstacle detected by the obstacle detection unit, a mode selection unit that selects an automatic mode or a manual mode as a travel mode of the self-propelled inspection robot when the inspection continuity determination unit determines that the self-propelled inspection robot cannot continue the inspection, a control unit that makes the self-propelled inspection robot automatically travel when the inspection continuity determination unit determines that the self-propelled inspection robot can continue the inspection and when the mode selection unit selects the automatic mode, and makes the self-propelled inspection robot travel by a user's operation when the mode selection unit selects the manual mode, and an input/output unit that inputs a command from the user.

According to the invention, it is possible to provide a self-propelled inspection robot capable of continuing an inspection even when the robot cannot travel on a predetermined travel route for inspection due to an obstacle.

### BRIEF DESCRIPTION OF THE DRAWINGS

FIG. 1 is a schematic diagram for explaining the operation of a self-propelled inspection robot according to a first embodiment of the invention;

FIG. 2A is a diagram illustrating the configuration of the self-propelled inspection robot according to the first embodiment of the invention;

FIG. 2B is a diagram illustrating the configuration of the self-propelled inspection robot according to the first embodiment of the invention;

FIG. 3 is a block diagram illustrating the configuration of the self-propelled inspection robot according to the first embodiment of the invention;

FIG. 4 is a flowchart illustrating a normal process and operation of the self-propelled inspection robot according to the first embodiment of the invention;

FIG. 5 is a block diagram illustrating the configuration of a self-propelled inspection robot according to a second embodiment of the invention;

FIG. 6 is a flowchart illustrating the process and operation of the self-propelled inspection robot according to the second embodiment of the invention;

FIG. 7 is a flowchart illustrating the process of a mode selection unit in the self-propelled inspection robot according to the second embodiment of the invention;

FIG. 8A is a diagram illustrating an operation example of the self-propelled inspection robot when an automatic avoidance mode is selected;

FIG. 8B is a diagram illustrating an operation example of the self-propelled inspection robot when an automatic detour mode is selected;

FIG. 8C is a diagram illustrating an operation example of the self-propelled inspection robot when an automatic evacuation mode is selected;

FIG. 8D is a diagram illustrating an operation example of the self-propelled inspection robot when an automatic standby mode is selected;

FIG. 9 is a flowchart illustrating the process of the mode selection unit in a self-propelled inspection robot according to a third embodiment of the invention;

FIG. 10 is a block diagram illustrating the configuration of a travel route generation unit included in a self-propelled inspection robot 1 according to a fourth embodiment of the invention;

FIG. 11 is a flowchart of the process in which the travel route generation unit generates a detour route in the fourth embodiment of the invention;

FIG. 12 is a diagram illustrating a predetermined travel route of the self-propelled inspection robot in a normal state in the fourth embodiment of the invention;

FIG. 13 is a diagram illustrating a travel route of the self-propelled inspection robot when there is an inspection point that is not in time for the specified inspection execution time in the fourth embodiment of the invention;

FIG. 14 is a flowchart illustrating the process of the travel route generation unit when an inspection continuity determination unit determines that the self-propelled inspection robot cannot travel on a predetermined travel route in a fifth embodiment of the invention; and

FIG. 15 is a flowchart illustrating the process of a travel route generation unit when the inspection continuity determination unit determines that the self-propelled inspection robot cannot travel on a predetermined travel route in a sixth embodiment of the invention.

### DESCRIPTION OF THE PREFERRED EMBODIMENTS

A self-propelled inspection robot according to the invention can autonomously travel on a predetermined travel route to inspect an equipment in a power facility such as a power plant or a power substation. Even if the self-propelled inspection robot according to the invention cannot travel on a predetermined travel route due to an obstacle or the like and cannot automatically continue the inspection, it can take appropriate measures and continue the inspection.

Hereinafter, the self-propelled inspection robot according to the embodiment of the invention will be described with reference to the drawings. In the drawings used in the present specification, the same or corresponding elements may be designated by the same reference numerals, and repeated description of these elements may be omitted.

### First Embodiment

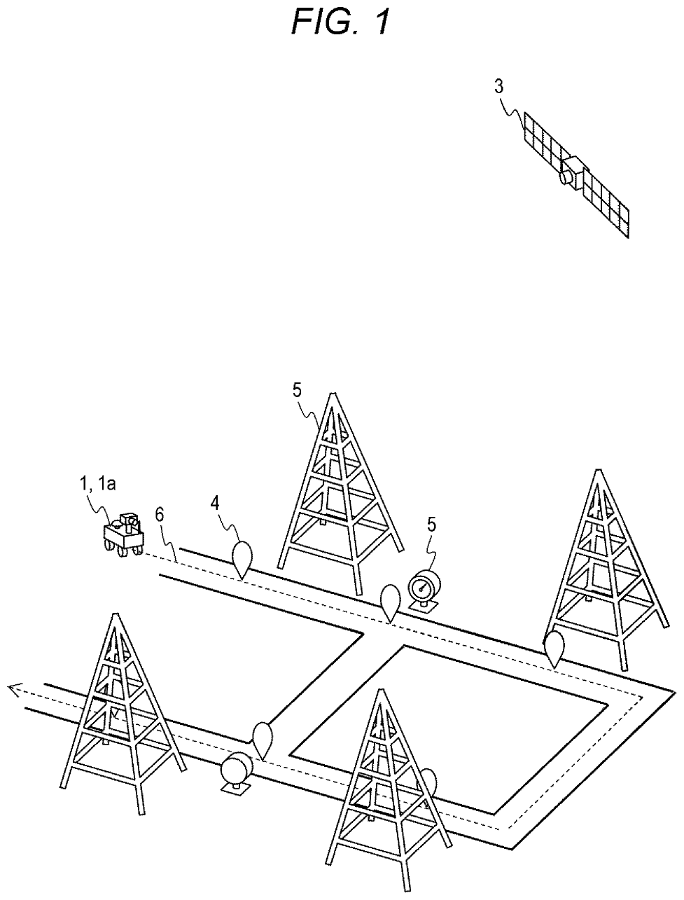

The self-propelled inspection robot according to the first embodiment of the invention will be described with reference to FIGS. 1 to 4.

FIG. 1 is a schematic diagram for explaining the operation of the self-propelled inspection robot according to this embodiment. As an example, FIG. 1 illustrates a self-propelled inspection robot 1 that travels in a power facility and inspects an inspection target equipment (for example, power substation, etc.).

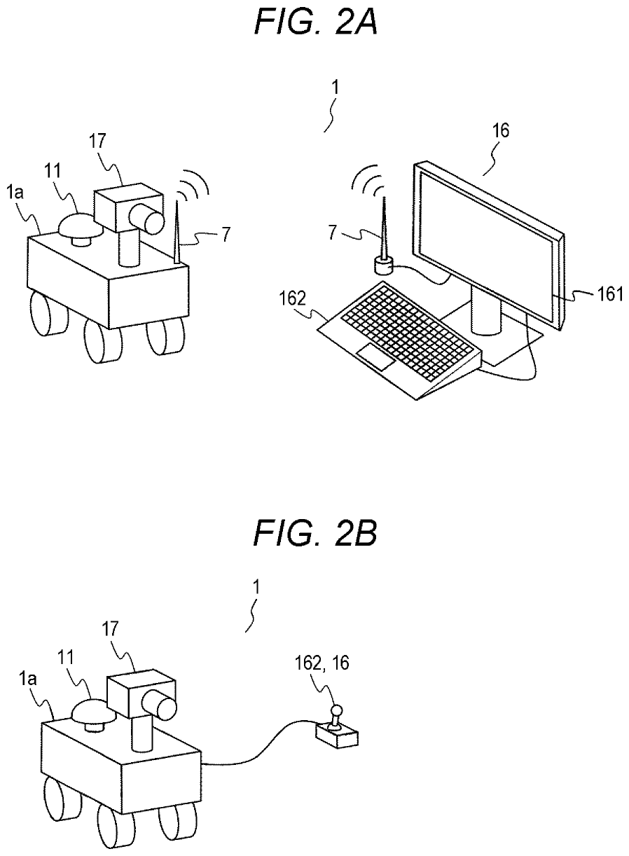

FIGS. 2A and 2B are diagrams illustrating the configuration of the self-propelled inspection robot 1.

The self-propelled inspection robot 1 includes a traveling unit 1a that travels on a predetermined travel route 6. The traveling unit 1a includes a self-position estimation unit 11 and an inspection unit 17. In the following, the traveling unit 1a may be referred to as the self-propelled inspection robot 1.

The self-position estimation unit 11 is an element that estimates and obtains the position of the self-propelled inspection robot 1 (traveling unit 1a). For example, the position of the self-propelled inspection robot 1 can be estimated by receiving a signal of a GPS satellite 3. The self-propelled inspection robot 1 can autonomously travel while finding its own position by the self-position estimation unit 11. The inspection unit 17 is an element for inspect an inspection target equipment 5 (for example, power substation including overhead lines, steel towers, instruments, etc.), which will be described in detail later.

The self-propelled inspection robot 1 reaches an inspection location 4 while autonomously traveling on the predetermined travel route 6, and uses the inspection unit 17 to check whether the inspection target equipment 5 has an abnormality in appearance or an abnormality in the instrument. The travel route 6 is configured by one or a plurality of roads. The travel route 6 also defines which part of the road to drive (for example, when there are a plurality of lanes on the road, which lane to travel). The self-propelled inspection robot 1 receives information about the travel route 6 (for example, information about the road constituting the travel route 6, information about the road width of the road constituting the travel route 6, information about which part of the road to travel, etc.). The self-propelled inspection robot 1 can automate the periodic inspections in the power facility, which are conventionally performed manually, and save labor.

The self-propelled inspection robot 1 further includes an input/output unit 16. The user of the self-propelled inspection robot 1 can send a command to the self-propelled inspection robot 1 by using the input/output unit 16 as needed. The input/output unit 16 is not limited in the technology, the constituent equipment, and the installation location as long as it can input the command from the user.

As illustrated in FIG. 2A, the input/output unit 16 may include, for example, a display unit 161 such as a display and an input unit 162 such as a keyboard. The self-propelled inspection robot 1 may include a plurality of communication devices 7, and the input/output unit 16 may wirelessly communicate with the traveling unit 1a.

As illustrated in FIG. 2B, the input unit 162 of the input/output unit 16 may be, for example, a joystick type controller. Further, the input unit 162 may communicate with the traveling unit 1a by wire.

The inspection result obtained by the inspection unit 17 may be transmitted to the user of the self-propelled inspection robot 1 by being output by the input/output unit 16. The user to whom the inspection result is transmitted can take appropriate measures according to the inspection result. For example, the user removes a nest of wild animals if the equipment has a nest, and performs maintenance on the instrument when an abnormality is detected in the instrument.

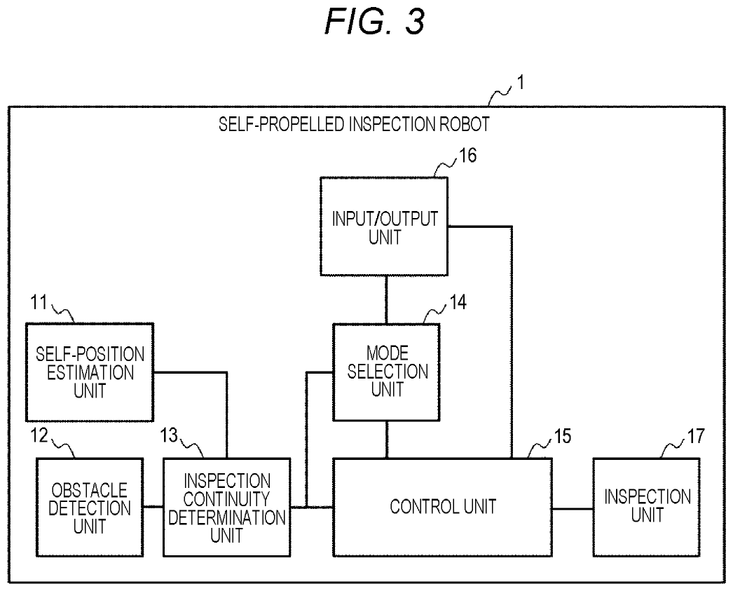

FIG. 3 is a block diagram illustrating the configuration of the self-propelled inspection robot 1 according to this embodiment. The self-propelled inspection robot 1 includes the self-position estimation unit 11, an obstacle detection unit 12, an inspection continuity determination unit 13, a mode selection unit 14, a control unit 15, the input/output unit 16, and the inspection unit 17.

As described above, the self-position estimation unit 11 is an element that estimates and obtains the position of the self-propelled inspection robot 1. For the self-position estimation unit 11, for example, Global Positioning System (GPS) technology can be used outdoors, and Simultaneous Localization and Mapping (SLAM) technology can be used indoors. Any technology or equipment can be used for the self-position estimation unit 11 as long as it can estimate the position of the self-propelled inspection robot 1 (traveling unit 1a) in the power facility.

The obstacle detection unit 12 is an element for detecting obstacles existing around the self-propelled inspection robot 1. The obstacle detection unit 12 can be configured by sensors such as a laser range finder, an ultrasonic sensor, a camera, and a stereo camera which can acquire information such as the presence or absence of obstacles or structures existing around the self-propelled inspection robot 1. Further, the obstacle detection unit 12 may include an external information analysis unit (not illustrated) that analyzes the acquired result and calculates the size and position of the obstacle.

The inspection continuity determination unit 13 is an element for constantly determining whether the self-propelled inspection robot 1 traveling on the predetermined travel route 6 in the power facility can continue the inspection of the inspection target equipment 5. The inspection continuity determination unit 13 determines whether the self-propelled inspection robot 1 can travel on the predetermined travel route 6, and if it cannot travel, it is determined that the self-propelled inspection robot 1 cannot continue the inspection of the inspection target equipment 5. The inspection continuity determination unit 13 determines whether the self-propelled inspection robot 1 can continue to travel on the predetermined travel route 6 based on information such as the position of the self-propelled inspection robot 1 estimated by the self-position estimation unit 11, the obstacle detected by the obstacle detection unit 12, and an operating situation of the equipment in the self-propelled inspection robot 1. The operating situation of the equipment included in the self-propelled inspection robot 1 includes, for example, whether the obstacle detection unit 12, a drive unit (not illustrated) of the self-propelled inspection robot 1, and the communication device 7 and the like are operating normally.

A case where the inspection continuity determination unit 13 determines that the self-propelled inspection robot 1 cannot travel on the predetermined travel route 6 may include, for example, a case where there is an obstacle on the travel route 6, a case where there are many pedestrians around the self-propelled inspection robot 1 and it is dangerous for the self-propelled inspection robot 1 to travel, and a case where the obstacle detection unit 12 or the drive unit of the self-propelled inspection robot 1 is out of order and not operating normally. In addition, the inspection continuity determination unit 13 can determine that the self-propelled inspection robot 1 cannot travel even in a case where the detection accuracy of the obstacle obtained by the obstacle detection unit 12 is not good, that is, for example, a case where the accuracy of the position of the obstacle is poor, a case where a sensor mounted in the obstacle detection unit 12 does not sufficiently function due to climates or weather conditions. Further, the inspection continuity determination unit 13 can determine that the self-propelled inspection robot 1 cannot travel even when the radio wave condition is poor and cannot communicate with the user of the self-propelled inspection robot 1. In this way, the inspection continuity determination unit 13 can determine that the self-propelled inspection robot 1 cannot travel and the inspection of the inspection target equipment 5 cannot be continued in the plurality of cases illustrated above.

The mode selection unit 14 is an element that selects a travel mode of the self-propelled inspection robot 1 when the inspection continuity determination unit 13 determines that the self-propelled inspection robot 1 cannot continue the inspection of the inspection target equipment 5. The mode selection unit 14 selects an automatic mode or a manual mode as the travel mode of the self-propelled inspection robot 1. The automatic mode is a mode in which the self-propelled inspection robot 1 automatically travels as determined in advance. The manual mode is a mode in which the self-propelled inspection robot 1 manually travels by the user's operation. The mode selection unit 14 determines the travel mode of the self-propelled inspection robot 1 based on at least one of the position and size of the obstacle, the operating situation of the equipment included in the self-propelled inspection robot 1, the user's instruction, and the like. In addition, the mode selection unit 14 can select the manual mode when the self-propelled inspection robot 1 stays at the current location for a predetermined period of time or longer.

The control unit 15 is an element for controlling the self-propelled inspection robot 1 and causing the self-propelled inspection robot 1 to travel along the travel route 6. In the automatic mode, the control unit 15 causes the self-propelled inspection robot 1 to automatically travel as determined in advance, and in the manual mode, the control unit 15 causes the self-propelled inspection robot 1 to travel manually by the user's operation via the input/output unit 16. The control unit 15 may include a drive unit for driving and traveling the self-propelled inspection robot 1 (traveling unit 1a). The drive unit may include, for example, a traveling mechanism such as a tire, a crawler, and a leg, and a power unit such as a battery for driving the traveling mechanism. The power unit may include an energy harvesting equipment such as a photovoltaic power generation device, and may drive the travel mechanism with the power generated by the energy harvesting equipment.

The input/output unit 16 inputs a command from the user when the mode selection unit 14 selects the manual mode. The input/output unit 16 may notify the user when the manual mode is selected. Further, the input/output unit 16 may include a device capable of outputting an alarm for calling safety to the surroundings and a voice for giving an instruction or request to the surroundings.

As described above, the inspection unit 17 is an element for inspecting the inspection target equipment 5, and may include, for example, a camera. The inspection unit 17 equipped with a camera may include an image analysis unit that analyzes a captured image by machine learning, extracts the difference from the image captured in the previous inspection, and extracts the value of the instrument. The inspection unit 17 may include a device other than a camera, and may include a thermography for temperature measurement or a laser range finder for shape measurement, for example.

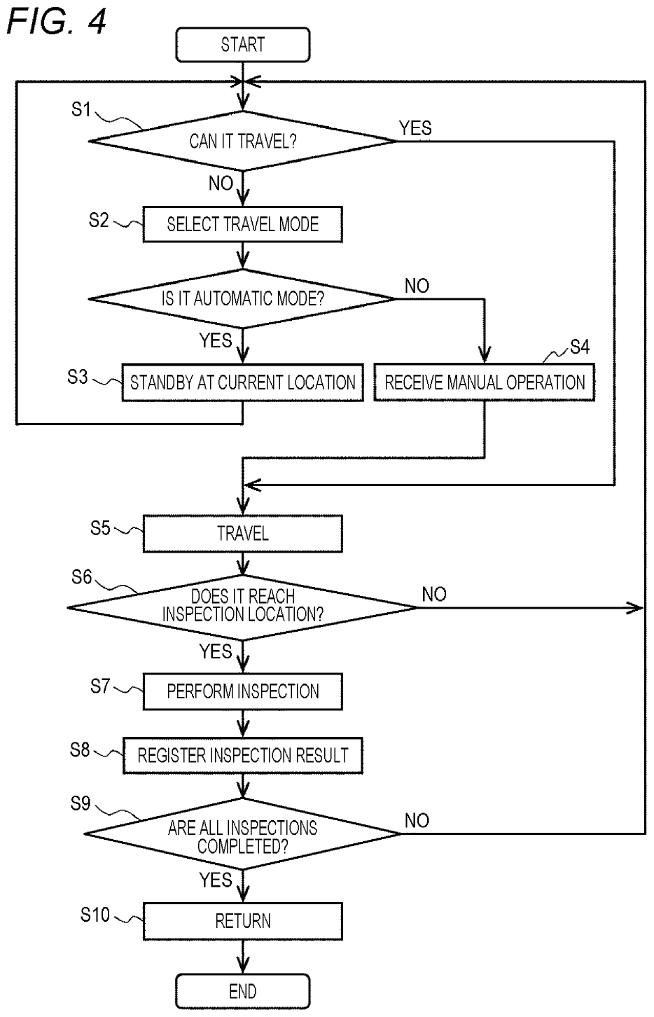

FIG. 4 is a flowchart illustrating the normal process and operation of the self-propelled inspection robot 1.

In S1, the inspection continuity determination unit 13 determines whether the self-propelled inspection robot 1 can travel on the predetermined travel route 6, and if it can travel, the process proceeds to S5, and if it cannot travel, to S2.

In S2, the mode selection unit 14 selects the travel mode of the self-propelled inspection robot 1. As described above, the mode selection unit 14 selects the automatic mode or the manual mode as the travel mode of the self-propelled inspection robot 1 based on at least one of the position and size of the obstacle, the operating situation of the equipment of the self-propelled inspection robot 1, the user's instruction, and the like. For example, when it can be determined that the obstacle does not prevent the self-propelled inspection robot 1 from traveling in the automatic mode, the mode selection unit 14 selects the automatic mode. Further, for example, when the obstacle detection unit 12 is not operating normally, or when the user determines that it is preferable for the user to operate the self-propelled inspection robot 1 to travel due to the presence of an obstacle, the mode selection unit 14 selects the manual mode. Further, as described above, the mode selection unit 14 can select the manual mode when the self-propelled inspection robot 1 stays at the current location for a predetermined period of time or longer. If the automatic mode is selected, the process proceeds to S3, and if the manual mode is selected, the process proceeds to S4.

S3 is a process when the automatic mode is selected, and the self-propelled inspection robot 1 waits at the current location. The self-propelled inspection robot 1 waits at the current location until it can travel again (S1).

S4 is a process when the manual mode is selected, and the self-propelled inspection robot 1 accepts a manual operation. The mode selection unit 14 can notify the user that the manual mode has been selected via the input/output unit 16. For example, the user inputs a command to the self-propelled inspection robot 1 via the input/output unit 16 by remote control for causing the self-propelled inspection robot 1 to travel on.

In S5, the self-propelled inspection robot 1 travels under the control of the control unit 15. The self-propelled inspection robot 1 travels in the automatic mode when it is determined that it can travel in S1. When it is determined that it cannot travel in S1, the self-propelled inspection robot 1 travels in the travel mode selected by the mode selection unit 14 in S2. In the automatic mode, the self-propelled inspection robot 1 automatically travels on the predetermined travel route 6. In the manual mode, the self-propelled inspection robot 1 travels manually by the user's operation. Further, the self-propelled inspection robot 1 may switch from traveling in the manual mode (manual driving) to traveling in the automatic mode (automatic driving) according to a user's instruction or automatically. For example, if the self-propelled inspection robot 1 can automatically travel, such as when there are no obstacles from the travel route 6 or when the self-propelled inspection robot 1 returns to the travel route 6, the self-propelled inspection robot 1 can switch from the manual driving to the automatic driving.

In S6, the self-position estimation unit 11 determines whether the self-propelled inspection robot 1 has reached the predetermined inspection location 4. When the self-propelled inspection robot 1 reaches the predetermined inspection location 4, the process proceeds to S7, and when it has not reached the inspection location 4, the process returns to S1.

The process from S1 to S6 is repeated every control cycle of the self-propelled inspection robot 1.

In S7, the inspection unit 17 inspects the inspection target equipment 5 at the predetermined inspection location 4.

In S8, the inspection unit 17 registers the obtained inspection results in an inspection result database (not illustrated) provided in the self-propelled inspection robot 1.

In S9, the control unit 15 determines whether all the inspections have been completed. If all inspections have not been completed, the process returns to S1 and repeats S1 to S9. When all inspections are completed, the process proceeds to S10.

At S10, the self-propelled inspection robot 1 returns to its predetermined position (returns to the nest). The predetermined position is, for example, a charging station for charging the battery included in the drive unit of the self-propelled inspection robot 1.

As described above, the self-propelled inspection robot 1 according to this embodiment manually travels by the user's operation and can continue the inspection even when there is an obstacle in the predetermined travel route 6 for inspection and the robot cannot travel on the travel route 6. Since the self-propelled inspection robot 1 according to this embodiment can travel manually when it stays at the current location for a certain period of time or longer, it is possible to prevent the inspection from being delayed for a long time and to continue the inspection efficiently.

### Second Embodiment

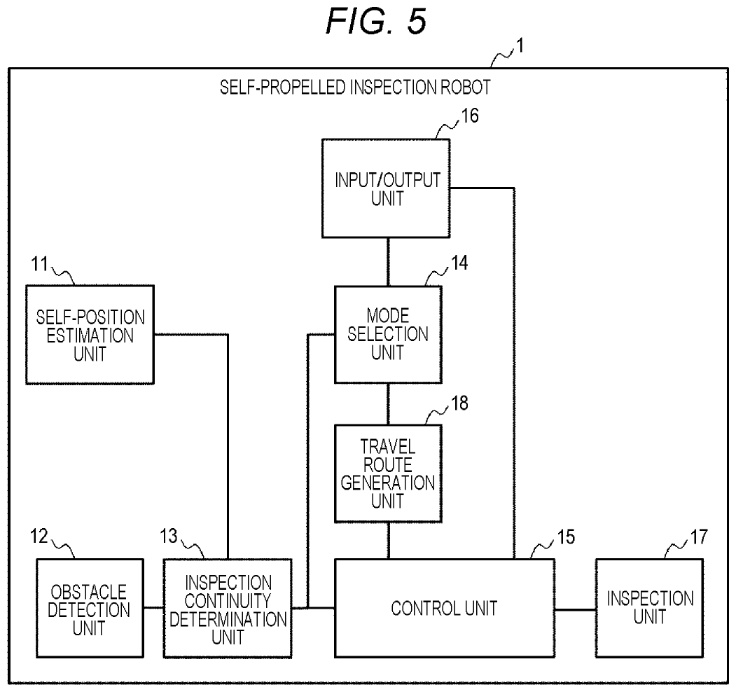

The self-propelled inspection robot 1 according to the second embodiment of the invention will be described with reference to FIGS. 5 to 8D. In the following, the self-propelled inspection robot 1 according to this embodiment will be described mainly about the difference from the self-propelled inspection robot 1 according to the first embodiment.

As illustrated in S1 to S3 of FIG. 4, the self-propelled inspection robot 1 according to the first embodiment waits at the current location when the inspection continuity determination unit 13 determines that it is impossible to travel on the predetermined travel route 6, and the mode selection unit 14 selects the automatic mode. Therefore, in the self-propelled inspection robot 1 according to the first embodiment, the inspection may be interrupted while waiting at the current location, and the inspection efficiency may decrease.

The self-propelled inspection robot 1 according to this embodiment has four automatic modes (automatic avoidance mode, automatic detour mode, automatic evacuation mode, and automatic standby mode), and the mode selection unit 14 suitably selects the automatic mode according to the state of obstacles, so that the inspection can be continued efficiently without causing unnecessary waiting time.

FIG. 5 is a block diagram illustrating the configuration of the self-propelled inspection robot 1 according to this embodiment. The self-propelled inspection robot 1 according to this embodiment is different from the self-propelled inspection robot 1 (FIG. 3) according to the first embodiment in that it is provided with a travel route generation unit 18, and the other points are similar to the self-propelled inspection robot 1 according to the first embodiment. The travel route generation unit 18 is an element that generates the travel route 6 for the self-propelled inspection robot 1 to automatically travel when the mode selection unit 14 selects the automatic mode.

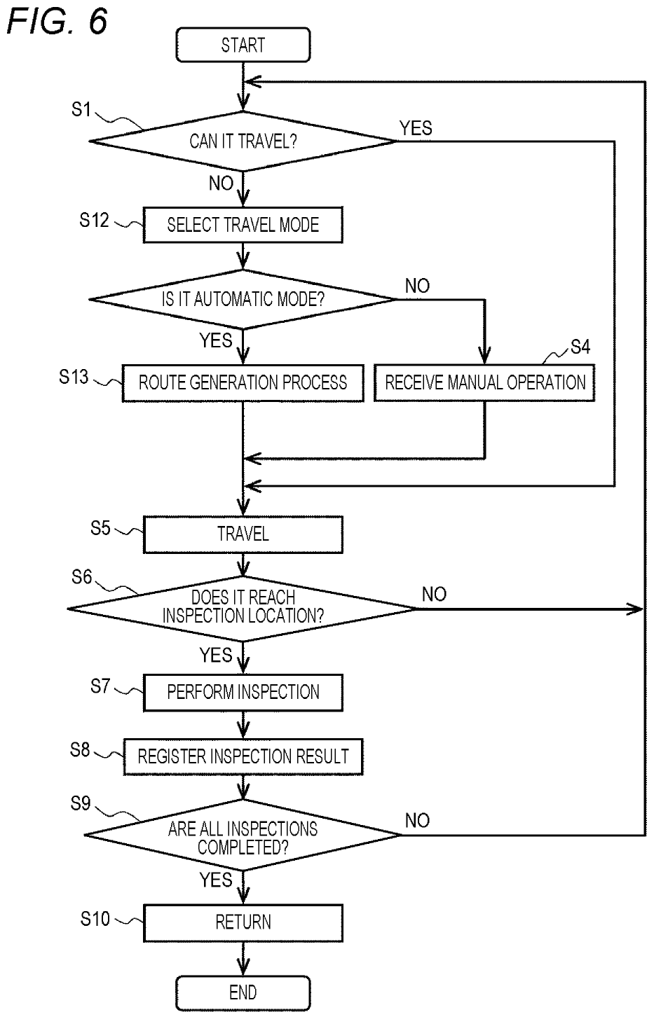

FIG. 6 is a flowchart illustrating the process and operation of the self-propelled inspection robot 1 according to this embodiment.

S1 is the same as in the first embodiment. However, if the self-propelled inspection robot 1 cannot travel on the predetermined travel route 6, the process proceeds to S12.

In S12, the mode selection unit 14 selects the travel mode of the self-propelled inspection robot 1. If the automatic mode is selected, the process proceeds to S13, and if the manual mode is selected, the process proceeds to S4.

The process of S4 and the process of S5 to S10 are the same as in the first embodiment.

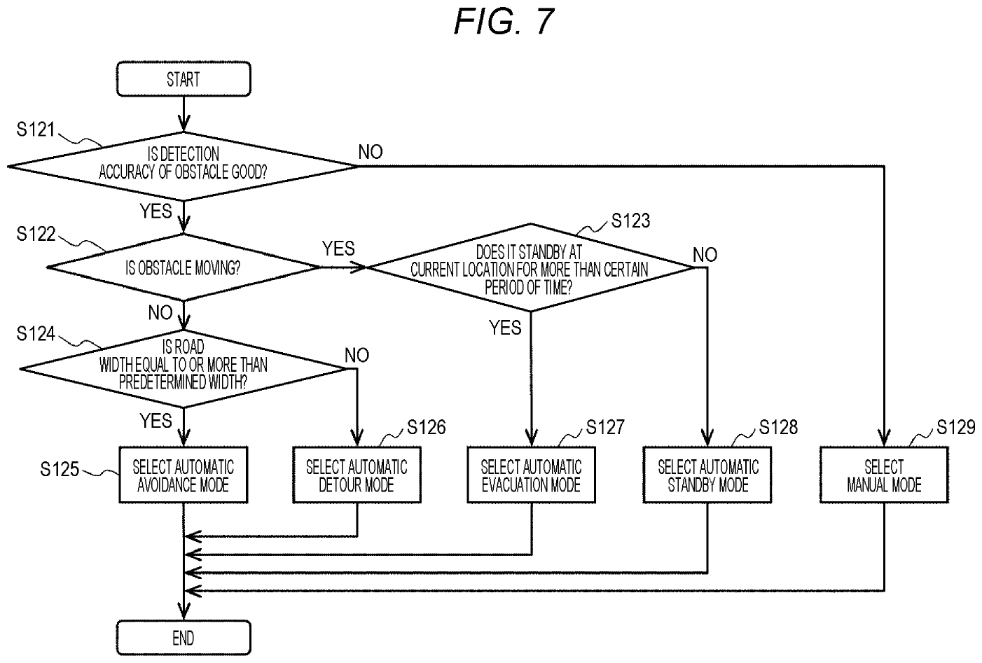

The travel mode selection process performed by the mode selection unit 14 of S12 will be described with reference to FIG. 7.

FIG. 7 is a flowchart illustrating the process of the mode selection unit 14 in the self-propelled inspection robot 1 according to this embodiment, and illustrates the process in S12 of FIG. 6.

In S121, the mode selection unit 14 determines whether the obstacle detection accuracy is good. The mode selection unit 14 proceeds to S129 to select the manual mode in a case where the detection accuracy of the obstacle is not good, that is, for example, a case where the accuracy of the position of the obstacle obtained by the obstacle detection unit 12 is poor, or a case where the sensor mounted in the obstacle detection unit 12 does not sufficiently function due to climates or weather conditions. If the obstacle detection accuracy is good, the process proceeds to S122.

In S122, the mode selection unit 14 determines whether the obstacle moves by using the result acquired by the obstacle detection unit 12. For example, the mode selection unit 14 determines that the obstacle is moving when the obstacle is actually moving or when the obstacle is recognized as a moving object such as a person or a car by using image analysis or the like. If it is determined that the obstacle moves, the process proceeds to S123, and if it is determined that the obstacle will not move, the process proceeds to S124.

In S123, the mode selection unit 14 determines whether the self-propelled inspection robot 1 stays at the current location for a predetermined period of time or longer. When the self-propelled inspection robot 1 has not stayed at the current location for a certain period of time or longer, the mode selection unit 14 selects the automatic standby mode (S128). When the self-propelled inspection robot 1 stays at the current location for a certain period of time or longer, the mode selection unit 14 selects the automatic evacuation mode (S127).

In S124, the mode selection unit 14 determines whether the road width of the road constituting the travel route 6 is equal to or greater than a predetermined width. When the road width of the road constituting the travel route 6 is smaller than a predetermined width, the mode selection unit 14 selects the automatic detour mode (S126). When the road width of the road constituting the travel route 6 is equal to or larger than a predetermined width, the mode selection unit 14 selects the automatic avoidance mode (S125).

The mode selection unit 14 may perform the process illustrated in FIG. 7 in an order different from the order described above, or may select a mode under conditions different from the conditions described above. Further, the mode selection unit 14 may execute a mode other than the modes described above, and may not execute any of the above modes.

When the automatic mode (automatic avoidance mode, automatic detour mode, automatic evacuation mode, and automatic standby mode) is selected in S12 of FIG. 6, the process proceeds to S13.

In S13, the travel route generation unit 18 generates the travel route 6 according to the selected automatic mode. The travel route 6 is configured by one or a plurality of roads.

When the selected automatic mode is the automatic avoidance mode (S125), the travel route generation unit 18 generates an avoidance route for the self-propelled inspection robot 1. The avoidance route is a route in which the self-propelled inspection robot 1 travels while avoiding obstacles in the road constituting the travel route 6 while traveling. Since the self-propelled inspection robot 1 can travel on the road constituting the travel route 6 without coming into contact with obstacles, the self-propelled inspection robot 1 travels on the avoidance route in the road constituting the travel route 6, and returns to the predetermined travel route 6 after traveling on the avoidance route. The travel route generation unit 18 generates an avoidance route based on the output of the obstacle detection unit 12, for example, by using a local path planning technique.

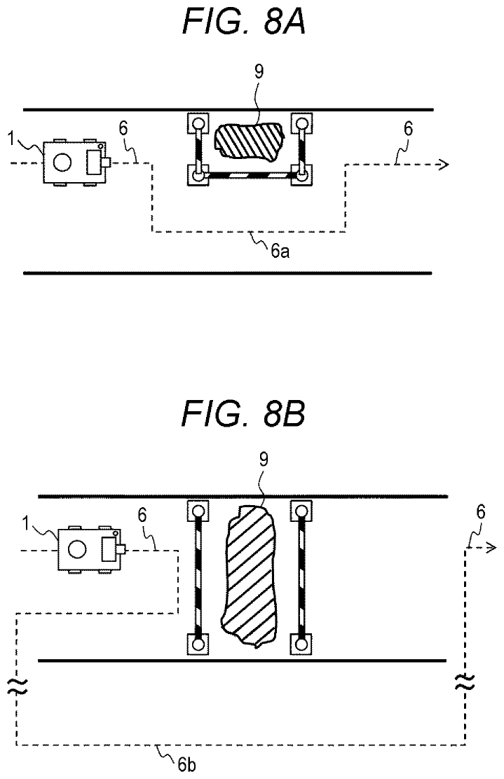

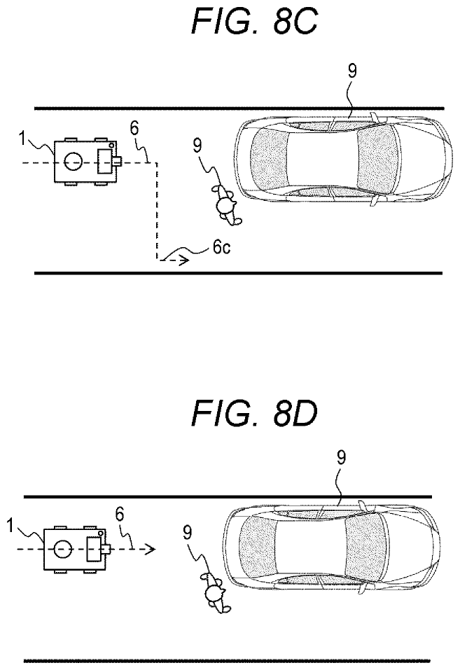

FIG. 8A is a diagram illustrating an operation example of the self-propelled inspection robot 1 when the automatic avoidance mode is selected. When there is an obstacle 9 (for example, a construction site) that does not move to the predetermined travel route 6 and the road width of the road constituting the travel route 6 is equal to or larger than the predetermined width, the self-propelled inspection robot 1 is less likely to come into contact with the obstacle 9 even traveling in the road constituting the travel route 6. Therefore, the self-propelled inspection robot 1 travels an avoidance route 6a that avoids the obstacle 9 in the road constituting the travel route 6 and returns to the predetermined travel route 6 after avoiding the obstacle 9.

When the selected automatic mode is the automatic detour mode (S126), the travel route generation unit 18 generates a detour route for the self-propelled inspection robot 1. The detour route is a route in which the self-propelled inspection robot 1 detours the obstacle 9 through a road different from the road constituting the travel route 6 while traveling. Since it is difficult for the self-propelled inspection robot 1 to travel on the road that constitutes the travel route 6 without coming in contact with the obstacle 9, the self-propelled inspection robot 1 travels on a detour route that is different from the road that constitutes the travel route 6 and returns to the predetermined travel route 6 after traveling the detour route. The travel route generation unit 18 generates a detour route by using, for example, a global path planning technique.

The travel route generation unit 18 may register the road on which the self-propelled inspection robot 1 cannot travel in an information storage unit (not illustrated) of the self-propelled inspection robot 1. Further, the travel route generation unit 18 may refer to a non-travelable road registered in the information storage unit when generating a detour route.

FIG. 8B is a diagram illustrating an operation example of the self-propelled inspection robot 1 when the automatic detour mode is selected. When there is the obstacle 9 that does not move to the predetermined travel route 6 and the road width of the road constituting the travel route 6 is smaller than a predetermined width, it is difficult for the self-propelled inspection robot 1 to travel on the road constituting the travel route 6 without coming into contact with the obstacle 9. Therefore, the self-propelled inspection robot 1 travels a detour route 6b that is a road different from the road constituting the travel route 6, and returns to the predetermined travel route 6 after detouring the obstacle 9.

When the selected automatic mode is the automatic evacuation mode (S127), the travel route generation unit 18 generates an evacuation route for the self-propelled inspection robot 1. The evacuation route is a route for the self-propelled inspection robot 1 to travel to an evacuation location. The evacuation location is a location where the self-propelled inspection robot 1 temporarily stops and waits until it can travel on the predetermined travel route 6, and is determined by the travel route generation unit 18. Examples of the evacuation location include a preset location, a roadside location, and a location where safety can be ensured based on the output of the obstacle detection unit 12. The travel route generation unit 18 generates an evacuation route by using, for example, a local path planning technique. The self-propelled inspection robot 1 travels on the evacuation route, moves to the evacuation location, and stops and waits at the evacuation location until the inspection continuity determination unit 13 determines that the predetermined travel route 6 can be traveled. When the self-propelled inspection robot 1 becomes able to travel on the predetermined travel route 6, the self-propelled inspection robot 1 returns to the predetermined travel route 6 and travels on the predetermined travel route 6. The route for the self-propelled inspection robot 1 to return to the predetermined travel route 6 is automatically determined by the self-propelled inspection robot 1.

FIG. 8C is a diagram illustrating an operation example of the self-propelled inspection robot 1 when the automatic evacuation mode is selected. If there is the obstacle 9 (for example, a car or a person) moving to the predetermined travel route 6, and the self-propelled inspection robot 1 stays at the current location for a certain period of time or longer, the self-propelled inspection robot 1 travels on the evacuation route 6c to move to the evacuation location, and waits until the robot can travel on the travel route 6. If the self-propelled inspection robot 1 stays at the current location for a certain period of time or longer, there is a possibility to obstruct the path of the moving obstacle 9, and thus the robot moves to the evacuation location.

When the selected automatic mode is the automatic standby mode (S128), the self-propelled inspection robot 1 stops and waits at the current location for a predetermined period of time. The self-propelled inspection robot 1 on standby travels on the predetermined travel route 6 when the obstacle 9 moves and the inspection continuity determination unit 13 determines that the predetermined travel route 6 can be traveled.

FIG. 8D is a diagram illustrating an operation example of the self-propelled inspection robot 1 when the automatic standby mode is selected. When there is an obstacle 9 that moves to the predetermined travel route 6, the self-propelled inspection robot 1 stops at the current location because it is dangerous to travel on the predetermined travel route 6, and the robot waits for a predetermined period of time until the obstacle 9 moves and the predetermined travel route 6 can be traveled.

The self-propelled inspection robot 1 travels in S5 according to the travel mode selected by the mode selection unit 14 in S12. When the mode selection unit 14 selects the automatic mode, the self-propelled inspection robot 1 travels the route generated by the travel route generation unit 18 in S13 (in the case of the automatic avoidance mode, the automatic detour mode, and the automatic evacuation mode) or the predetermined travel route 6 (in the case of the automatic standby mode) after the process of S13 of FIG. 6 ends.

As described above, the self-propelled inspection robot 1 according to this embodiment selects the automatic mode suitable for the obstacle 9 depending on whether the obstacle 9 moves or does not move, and whether the self-propelled inspection robot 1 can avoid the obstacle 9. Therefore, the time for interrupting the inspection can be reduced and the inspection can be continued more efficiently.

### Third Embodiment

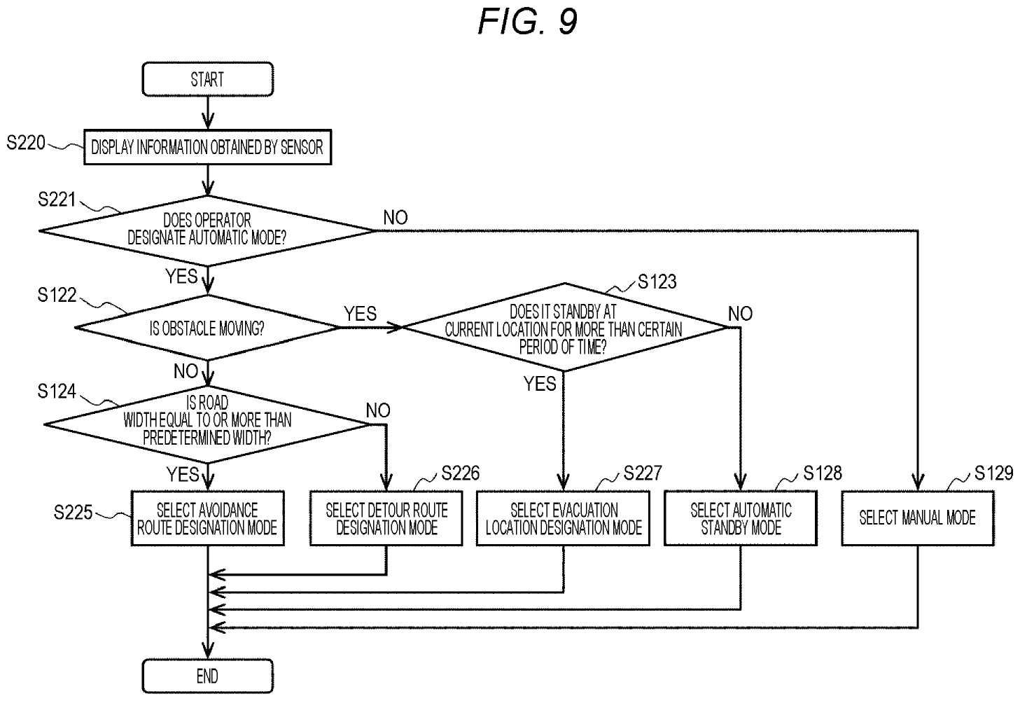

The self-propelled inspection robot 1 according to the third embodiment of the invention will be described with reference to FIG. 9. In the following, the self-propelled inspection robot 1 according to this embodiment will be described mainly about the difference from the self-propelled inspection robot 1 according to the first and second embodiments.

The self-propelled inspection robot 1 according to this embodiment has the automatic mode and the manual mode, and the automatic mode includes a semi-automatic mode. The semi-automatic mode is a travel mode in which the operation in the automatic mode is combined with a command from the user. As a specific example, in the semi-automatic mode, the user performs a part of the processing in the automatic mode (for example, the determination of the avoidance route 6a, the detour route 6b, the evacuation route 6c, and the evacuation location).

The self-propelled inspection robot 1 according to this embodiment has the automatic standby mode and three semi-automatic modes (avoidance route designation mode, detour route designation mode, and evacuation location designation mode) as automatic modes, which are the automatic mode described in the second embodiment. In the semi-automatic mode, the self-propelled inspection robot 1 automatically travels on a route designated by the user (for example, the avoidance route 6a, the detour route 6b, and the evacuation route 6c).

FIG. 9 is a flowchart illustrating the process of the mode selection unit 14 in the self-propelled inspection robot 1 according to this embodiment. Hereinafter, the points different from the flowchart illustrated in FIG. 7 will be described.

In S220, the self-propelled inspection robot 1 transmits the position of the self-propelled inspection robot 1 (traveling unit 1a) and the information acquired by the obstacle detection unit 12 to the input/output unit 16. The information acquired by the obstacle detection unit 12 is, for example, information (for example, an image or a voltage value) acquired by a sensor included in the obstacle detection unit 12. The display unit 161 of the input/output unit 16 displays the position of the self-propelled inspection robot 1 and the information obtained by the sensor of the obstacle detection unit 12.

The user selects the automatic mode or the manual mode by referring to the position of the self-propelled inspection robot 1 and the information obtained by the sensor of the obstacle detection unit 12 displayed on the display unit 161.

In S221, the mode selection unit 14 proceeds to S129 and selects the manual mode when the user selects the manual mode. The mode selection unit 14 proceeds to S122 when the user selects the automatic mode.

The process (branching) from S122 to S124 is the same as the flowchart illustrated in FIG. 7. However, S225, S226, and S227 of the processes after branching are different from those in FIG. 7.

When the obstacle 9 moves and the self-propelled inspection robot 1 has not stayed at the current location for a certain period of time or longer, the mode selection unit 14 selects the automatic standby mode (S128). In the case of the automatic standby mode, the self-propelled inspection robot 1 stops and waits at the current location for a predetermined period of time (FIG. 8D).

In this embodiment, the self-propelled inspection robot 1 can also wait at the current location for a time designated by the user in the automatic standby mode of S128. When the user designates a waiting time in S128, the process of S128 may be included in the semi-automatic mode as, for example, a waiting time designation mode instead of the automatic standby mode.

When the obstacle 9 moves and the self-propelled inspection robot 1 stays at the current location for a certain period of time or longer, the mode selection unit 14 selects the evacuation location designation mode, which is a semi-automatic mode (S227).

When the obstacle 9 does not move and the road width of the road constituting the travel route 6 is smaller than a predetermined width, the mode selection unit 14 selects the detour route designation mode which is a semi-automatic mode (S226).

When the obstacle 9 does not move and the road width of the road constituting the travel route 6 is equal to or larger than a predetermined width, the mode selection unit 14 selects the avoidance route designation mode which is a semi-automatic mode (S225).

The mode selection unit 14 may perform the process illustrated in FIG. 9 in an order different from the order described above, or may select a mode under conditions different from the conditions described above. Further, the mode selection unit 14 may execute a mode other than the modes described above, and may not execute any of the above modes.

In the case of the avoidance route designation mode (S225) in which the selected automatic mode is the semi-automatic mode, the user generates the avoidance route 6a of the self-propelled inspection robot 1 based on the position of the self-propelled inspection robot 1 and the information obtained by the sensor of the obstacle detection unit 12, which are displayed in the display unit 161, and designates the avoidance route 6a to the self-propelled inspection robot 1. At this time, the user may use the information on the map including the power facility. The self-propelled inspection robot 1 to which the avoidance route 6a is designated updates the travel route 6 so as to travel on the avoidance route 6a, and automatically travels in S5 of FIG. 6.

In the case of the detour route designation mode (S226) in which the selected automatic mode is the semi-automatic mode, the user generates the detour route 6b of the self-propelled inspection robot 1 based on the information of the map containing the power facility, and the position of the self-propelled inspection robot 1 and the information obtained by the sensor of the obstacle detection unit 12, which are displayed in the display unit 161, and designates the detour route 6b to the self-propelled inspection robot 1. The self-propelled inspection robot 1 to which the detour route 6b is designated updates the travel route 6 so as to travel on the detour route 6b, and automatically travels in S5 of FIG. 6.

In the case of the evacuation location designation mode (S227) in which the selected automatic mode is the semi-automatic mode, the user determines the evacuation location of the self-propelled inspection robot 1 based on the position of the self-propelled inspection robot 1 and the information obtained by the sensor of the obstacle detection unit 12, which are displayed in the display unit 161, and designates the evacuation location to the self-propelled inspection robot 1. At this time, the user may use the information on the map including the power facility. Next, the travel route generation unit 18 generates a route to the evacuation location designated by the user in S13 of FIG. 6 using the local path planning technique, and automatically travels in S5 of FIG. 6.

After reaching the evacuation location, the self-propelled inspection robot 1 stops and stands by. The route for the self-propelled inspection robot 1 to return to the predetermined travel route 6 may be designated by the user, or may be automatically determined by the self-propelled inspection robot 1 as in the case where the automatic evacuation mode is selected in the second embodiment (S127 of FIG. 7). Further, the timing at which the self-propelled inspection robot 1 ends the standby and starts running may be designated by the user, or may be a predetermined period of time as in the automatic mode of the second embodiment.

In the semi-automatic mode described above, the user may remotely monitor the self-propelled inspection robot 1 using the display unit 161 until it is determined that the self-propelled inspection robot 1 has returned to the predetermined travel route 6. Further, the user may switch the self-propelled inspection robot 1 to the manual mode when it is determined that the situation of the obstacle 9 has changed.

As described above, the self-propelled inspection robot 1 according to this embodiment is different from the self-propelled inspection robot 1 according to the second embodiment in which the manual mode is uniformly selected when the detection accuracy of the obstacle 9 is not good. The user designates the avoidance route 6a, the detour route 6b, or the evacuation location based on the position of the self-propelled inspection robot 1 and the information obtained by the sensor of the obstacle detection unit 12, regardless of the detection accuracy of the obstacle 9. After that, the self-propelled inspection robot 1 automatically travels, so that the burden on the user due to remote control can be reduced.

### Fourth Embodiment

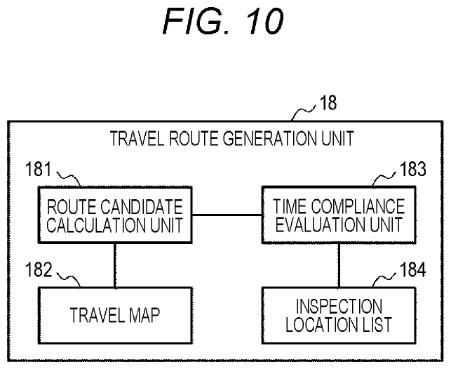

The self-propelled inspection robot 1 according to the fourth embodiment of the invention will be described with reference to FIGS. 10 to 13. In the following, the self-propelled inspection robot 1 according to this embodiment will be described mainly about the difference from the self-propelled inspection robot 1 according to the first to third embodiments.

When the self-propelled inspection robot 1 inspects the equipment, the inspection execution time may be predetermined for each inspection item. In such a case, the self-propelled inspection robot 1 needs to comply with the predetermined inspection execution time (specified inspection execution time) as much as possible.

The self-propelled inspection robot 1 according to this embodiment can generate the detour route 6b in which the number of inspection items that can comply with the specified inspection execution time is maximized when the self-propelled inspection robot 1 automatically generates the detour route 6b (FIG. 8B) in the automatic mode described in the second embodiment. The travel route generation unit 18 of the self-propelled inspection robot 1 generates the travel route 6 in which the inspection location 4 capable of complying with the specified inspection execution time is inspected more preferentially than the inspection location 4 incapable of complying with the specified inspection execution time (that is, to comply with the specified inspection execution time).

FIG. 10 is a block diagram illustrating the configuration of the travel route generation unit 18 included in the self-propelled inspection robot 1 according to this embodiment. The travel route generation unit 18 includes a travel map 182, a route candidate calculation unit 181, a time compliance evaluation unit 183, and an inspection location list 184.

The travel map 182 is a map that comprehensively includes the routes that the self-propelled inspection robot 1 can travel. The route candidate calculation unit 181 generates one or more candidates (route candidates) for the detour route 6b using the travel map 182. The time compliance evaluation unit 183 evaluates the degree of compliance with the inspection time for each of the route candidates generated by the route candidate calculation unit 181. The degree of compliance with the inspection time is an index illustrating the difference between the estimated inspection execution time and the specified inspection execution time, and indicates how close the estimated inspection execution time is to the specified inspection execution time. In the inspection location list 184, the target inspection location 4 and the inspection execution time predetermined for each inspection item at the inspection location 4 are recorded.

Although the travel map 182 and the inspection location list 184 are inside the travel route generation unit 18 in this embodiment, they may be outside the travel route generation unit 18. For example, the travel map 182 and the inspection location list 184 may be stored in an external storage device connected to the self-propelled inspection robot 1.

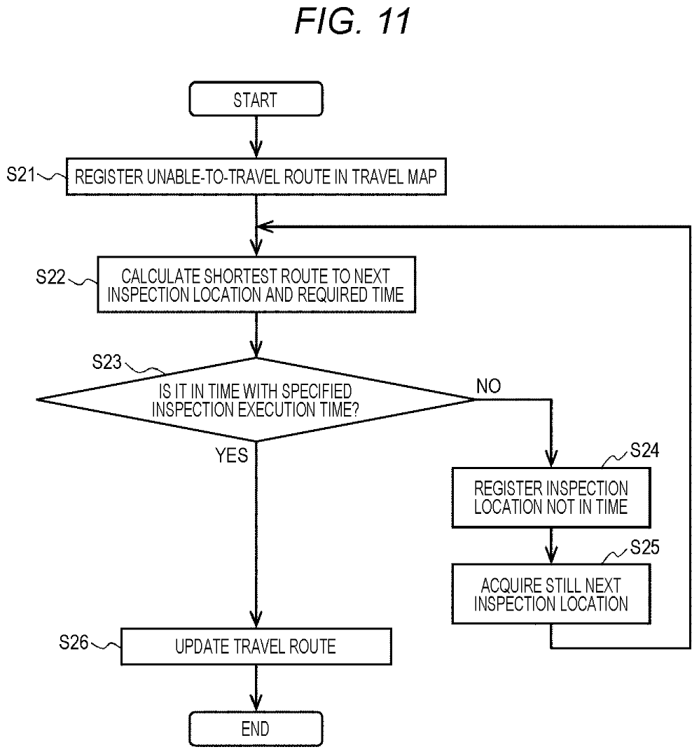

FIG. 11 is a flowchart of a process in which the travel route generation unit 18 generates the detour route 6b that maximizes the number of inspection items that can comply with the specified inspection execution time when the detour route 6b is generated (S13 in FIG. 6). In this embodiment, if there are many inspection locations 4 in time for the specified inspection execution time, the degree of compliance with the inspection time increases.

In S21, the travel route generation unit 18 registers the information about the travel route 6 determined by the inspection continuity determination unit 13 that the self-propelled inspection robot 1 cannot travel in the travel map 182.

In S22, the route candidate calculation unit 181 of the travel route generation unit 18 refers to the inspection location list 184 and the travel map 182, obtains the shortest route from the current position of the self-propelled inspection robot 1 to the next inspection location 4 (the candidate for the detour route 6b), and calculates the time required for the self-propelled inspection robot 1 to reach the next inspection location 4. For this calculation, a route search algorithm such as Dijkstra's algorithm or Aster search algorithm can be used.

In S23, the time compliance evaluation unit 183 of the travel route generation unit 18 evaluates the candidate of the detour route 6b obtained by the route candidate calculation unit 181 in S22. The time compliance evaluation unit 183 refers to the inspection location list 184, assumes that it will take only the time required in S22 for the self-propelled inspection robot 1 to reach the next inspection location 4, obtains the estimated inspection execution time of the next inspection location 4, and determines whether the self-propelled inspection robot 1 is in time for the specified inspection execution time at the next inspection location 4. The time compliance evaluation unit 183 evaluates the degree of compliance with the inspection time based on the difference between the estimated inspection execution time and the specified inspection execution time. If the degree of compliance with the inspection time is equal to or more than a predetermined threshold, it is determined that the robot is in time for the specified inspection execution time. If it is not in time for the specified inspection execution time, the process proceeds to S24, and if it is in time, the process proceeds to S26.

In S24, the inspection locations 4 that are not in time for the specified inspection execution time are registered in the inspection result database (not illustrated) provided in the self-propelled inspection robot 1.

In S25, the travel route generation unit 18 refers to the inspection location list 184 and further acquires the next inspection location 4. When the travel route generation unit 18 further acquires the next inspection location 4, the process proceeds to S22 and repeats S22 to S25. By repeating this process, the route candidate calculation unit 181 generates one or more candidates for the detour route 6b.

S26 is a process when the inspection location 4 that is in time for the specified inspection execution time is found in S23. In S26, the travel route generation unit 18 updates the travel route 6. The travel route 6 is updated as follows, for example.

The travel route generation unit 18 combines the shortest route to the next inspection location 4 obtained in S22 and the travel route 6 (the predetermined travel route 6) from the next inspection location 4 to the last inspection location 4, and generates the travel route 6 from the current location of the self-propelled inspection robot 1 to the last inspection location 4. Further, the travel route generation unit 18 starts from the last inspection location 4 and goes around the inspection locations 4 which have not been inspected (the inspection locations 4 to which the inspection has not performed because it is not in time for the specified inspection execution time) in a predetermined order so as to generate the shortest route up to the return location. Then, the travel route generation unit 18 combines the travel route 6 to the generated last inspection location 4 and the shortest route up to the generated return location, and obtains the travel route 6 for the self-propelled inspection robot 1 to execute the inspection. The travel route generation unit 18 updates the travel route 6 in this way in S26.

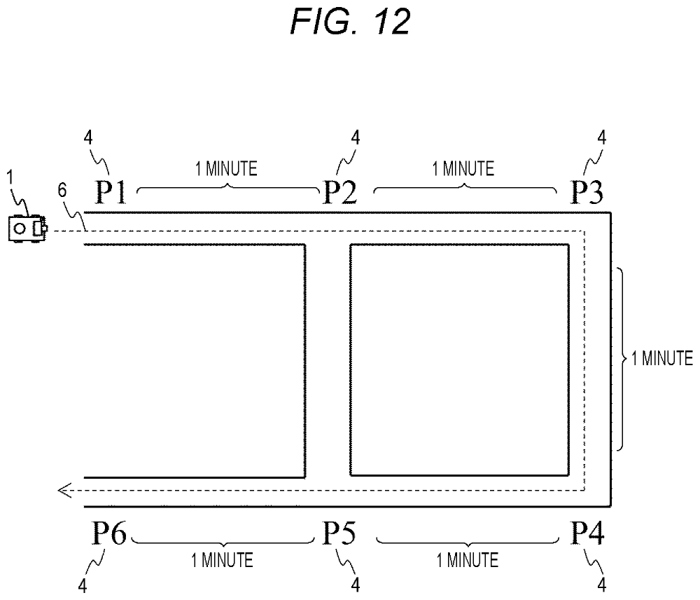

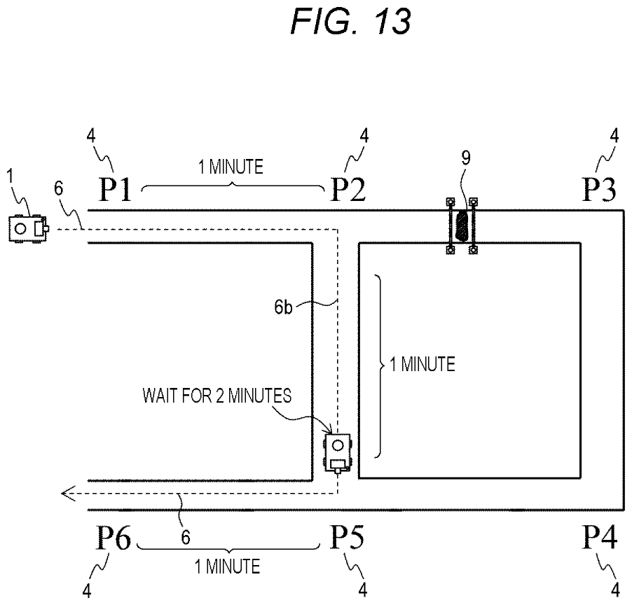

An example of the travel route 6 generated by the travel route generation unit 18 will be described with reference to FIGS. 12 and 13.

FIG. 12 is a diagram illustrating a predetermined travel route 6 of the self-propelled inspection robot 1 in a normal state. There is no obstacle 9 on the travel route 6 illustrated in FIG. 12. The self-propelled inspection robot 1 inspects six inspection locations 4 from P1 to P6. The inspection time of P1 is the inspection start time, and the inspection times of P2, P3, P4, P5, and P6 are the times when 1 minute, 2 minutes, 3 minutes, 4 minutes, and 5 minutes have passed from the inspection start time, respectively. The self-propelled inspection robot 1 travels around P1, P2, P3, P4, P5, and P6 in this order, and inspects the inspection locations 4 from P1 to P6.

FIG. 13 is a diagram illustrating the travel route 6 of the self-propelled inspection robot 1 when there is an inspection location 4 that is not in time for the specified inspection execution time. FIG. 13 illustrates an example in which an obstacle 9 exists between P2 and P3 of the inspection location 4 in the travel route 6 illustrated in FIG. 12.

When the obstacle 9 exists as illustrated in FIG. 13, the self-propelled inspection robot 1 cannot travel from P2 to P3 according to the travel route 6 illustrated in FIG. 12. Therefore, the travel route generation unit 18 generates the detour route 6b. At this time, if P2 is inspected, then the robot travels to P3 through the detour route 6b to inspect P3, and then P4, P5, and P6 are inspected, it is not possible to comply with the specified inspection execution time at the four locations of P3 to P6.

Therefore, in this embodiment, the self-propelled inspection robot 1 goes straight from P2 to P5 after inspecting P2, waits on the detour route 6b for 2 minutes before reaching P5 to comply with the specified inspection execution time, and then inspects P5 and P6. After that, the self-propelled inspection robot 1 moves to P3 and P4 and inspects P3 and P4. The travel route generation unit 18 updates the travel route 6 in this way in S26 of FIG. 11. In such a travel route 6, there are only two inspection locations 4, P3 and P4, where the specified inspection execution time cannot be complied.

The place and time for the self-propelled inspection robot 1 to wait are determined in S26 of FIG. 11 so that the travel route generation unit 18 can comply with the specified inspection execution time (if necessary, the shortest route obtained in S22 and the required time are used). The self-propelled inspection robot 1 may notify the user via the input/output unit 16 that the specified inspection execution time in P3 and P4 could not be complied.

In the self-propelled inspection robot 1 according to this embodiment, there are many inspection locations 4 that are in time for the specified inspection execution time, and the inspection time can be made as constant as possible at each inspection location 4, and the inspection conditions and inspection execution intervals can be set as constant as possible. For this reason, when the self-propelled inspection robot 1 according to this embodiment is used, it becomes easy to extract abnormal inspection results and grasp the tendency of inspection results, and it is possible to improve predictive maintenance to predict abnormalities before they occur. Further, it is possible to reduce the equipment replacement cost.

### Fifth Embodiment

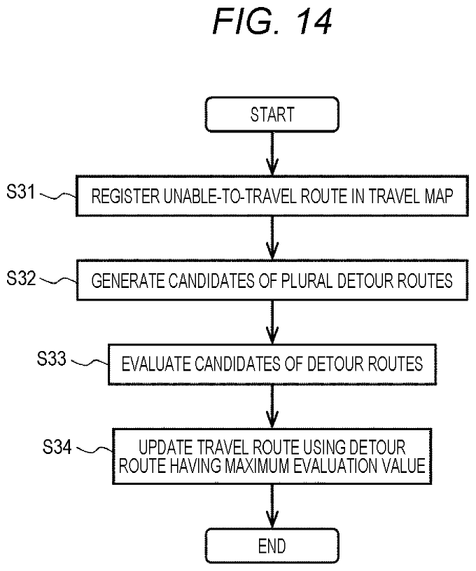

The self-propelled inspection robot 1 according to the fifth embodiment of the invention will be described with reference to FIG. 14. In the following, the self-propelled inspection robot 1 according to this embodiment will be described mainly about the difference from the self-propelled inspection robot 1 according to the first to fourth embodiments.

If there is the travel route 6 that cannot be traveled due to the obstacle 9 or the like, there is a possibility that some inspection items cannot be inspected as in a predetermined plan. For example, the remaining battery level of the drive unit of the self-propelled inspection robot 1 may be insufficient due to a change in the travel route 6 and all inspections cannot be performed, or if the position and angle to capture the inspection target may be inappropriate due to the presence of the obstacle 9.

In the self-propelled inspection robot 1 according to this embodiment, the user can change the inspection plan and carry out the inspection for the convenience of the user to the utmost when the predetermined inspection plan cannot always be complied.

The self-propelled inspection robot 1 according to this embodiment obtains a plurality of route candidates by the route candidate calculation unit 181 (S22 of FIG. 11) in the process of generating the detour route 6b so that the travel route generation unit 18 observes the inspection time described in the fourth embodiment (FIG. 11), and evaluates each route candidate by the time compliance evaluation unit 183 (S23 in FIG. 11). In this embodiment, when the time compliance evaluation unit 183 evaluates each route candidate, other parameters are added to the parameter which is the specified inspection execution time (that is, the degree of compliance with the inspection time), and each route candidate is evaluated using an evaluation parameter which includes the degree of compliance with the inspection time and the other parameters. The other parameters include, for example, at least one of information about the execution of the inspection (for example, reproducibility of inspection conditions, importance of inspection, and the number of inspection items) and the mileage of the self-propelled inspection robot 1 based on the remaining battery level. The time compliance evaluation unit 183 can evaluate each route candidate by weighting the evaluation parameters.

FIG. 14 is a flowchart illustrating the process of the travel route generation unit 18 in a case where the inspection continuity determination unit 13 in this embodiment determines that the self-propelled inspection robot 1 cannot travel on the predetermined travel route 6 due to the presence of the obstacle 9 or the like.

In S31, the travel route generation unit 18 registers the information about the travel route 6 determined by the inspection continuity determination unit 13 that the self-propelled inspection robot 1 cannot travel in the travel map 182.

In S32, the route candidate calculation unit 181 of the travel route generation unit 18 refers to the inspection location list 184 and the travel map 182, and generates a plurality of candidates for the detour route 6b that does not pass through the travel route 6 that cannot be traveled.

In S33, the time compliance evaluation unit 183 of the travel route generation unit 18 evaluates each of the candidates for the detour route 6b generated in S32 according to the evaluation parameters including the specified inspection execution time. Specifically, the time compliance evaluation unit 183 obtains an evaluation value J obtained by using the sum of the evaluation parameters for each of the candidates of the detour route 6b, as will be described later.

In S34, the travel route generation unit 18 adopts the candidate of the detour route 6b having the maximum evaluation value J obtained in S33 as the detour route 6b, and updates the travel route 6.

In S32, the route candidate calculation unit 181 generates candidates for a plurality of detour routes 6b, for example, as follows. When the travel route 6 that cannot be traveled occurs due to the obstacle 9 or the like, the route candidate calculation unit 181 lists a plurality of scheduled inspection locations 4 to be followed, and calculates the shortest route from the current position of the self-propelled inspection robot 1 with respect to each of the plurality of the listed inspection locations 4. For this calculation, a route search algorithm such as Dijkstra's algorithm or Aster search algorithm can be used. The route candidate calculation unit 181 obtains candidates for the plurality of detour routes 6b by combining the calculated shortest route and the predetermined travel route 6.

In S33, the time compliance evaluation unit 183 evaluates the candidate of the detour route 6b using the evaluation value J obtained using the sum of the evaluation parameters as illustrated in the following Expression (1), for example.

J=(Σ(αiTi+βiRi+γiIi)+δN)×(Llim−L)/|Llim−L| (1)

The evaluation value J is obtained by performing a total calculation for all the inspection items i that can be inspected for each of the candidates of the detour route 6b.

In Expression (1), i is the number of the inspection item, and the summation symbol Σ represents the sum for i. αi, βi, γi, and δ are weighting coefficients, and values of 0 or more are set. Ti, Ri, and Ii are the degree of compliance with the inspection time for each inspection item, the reproducibility of inspection conditions, and the importance of inspection, all of which take positive values. N is the number of inspection items included in the candidates for the detour route 6b, and takes a positive value. L is the length (distance) of the candidate for the detour route 6b. Llim is the mileage of the self-propelled inspection robot 1 determined by the remaining battery level.

The degree Ti of compliance with the inspection time can be calculated by, for example, the following Expression (2).

Ti=1−(ti−ti_REF)2/(ti2+ti_REF2) (2)

In Expression (2), ti is the estimated inspection execution time for each inspection item, and ti_REF is the specified inspection execution time (specified value) for each inspection item.

The reproducibility Ri of inspection conditions may be obtained by the same method as that of the degree Ti of compliance with the inspection time using the specified value of the predetermined reproducibility Ri with parameters such as sunshine conditions (illuminance of sunlight and angle of sun), temperature, wind direction, and the position and angle when the inspection target is captured with a camera at the time of executing inspection. The larger the reproducibility Ri of the inspection conditions, the easier it is to extract abnormal inspection results and grasp the tendency of the inspection results. For example, when the sunshine condition for each inspection is constant, it becomes easy to extract the value of the meter of the inspection target equipment 5 by image analysis. Further, for example, when the outside air temperature for each inspection is constant, a more accurate measured value can be obtained from the instruments for measuring the temperature.

The importance Ii of inspection can be calculated by, for example, the following Expression (3).

Ii=ii/itotal (3)

In Expression (3), ii is a numerical value indicating the importance set for each inspection item, and itotal is the sum of the importance of all inspection items to be inspected. For ii, the higher the inspection target that requires frequent inspection, the larger the value is. For example, ii can be set to a continuous value between 0 and 1 with 0 for the least important inspection item and 1 for the most important inspection item. By evaluating the importance Ii of inspection, when the inspection plan has to be changed due to obstacles 9 or the like, the inspection items having low importance Ii of inspection are temporarily ignored, and the inspection items having high importance Ii of inspection can be prioritized for inspection.

The input/output unit 16 of the self-propelled inspection robot 1 can input evaluation parameters and weighting coefficients αi, βi, γi, and δ that are used to obtain the evaluation value J. The user can arbitrarily set the evaluation parameters and the weighting coefficients in the self-propelled inspection robot 1 in advance via the input/output unit 16. Further, the input/output unit 16 can display the evaluation value J. Further, the self-propelled inspection robot 1 can obtain the evaluation value J of the detour route 6b designated by the user in the detour route designation mode and display it on the input/output unit 16.

As described above, in the self-propelled inspection robot 1 according to this embodiment, when the predetermined inspection plan cannot always be complied due to the obstacle 9 or the like, the user can arbitrarily set the conditions to be emphasized in the inspection, and can execute the inspection under the set conditions. For example, if there is an inspection item for which an inspection target is to be always captured at a constant time and sunshine conditions, the inspection (capturing) can be performed with priority given to the constant inspection execution time and sunshine conditions. Further, when the inspection execution time and the sunshine conditions do not have to be constant, the inspection can be performed with priority given to other conditions. In this way, the self-propelled inspection robot 1 according to this embodiment can change the inspection plan and carry out the inspection for the convenience of the user.

### Sixth Embodiment

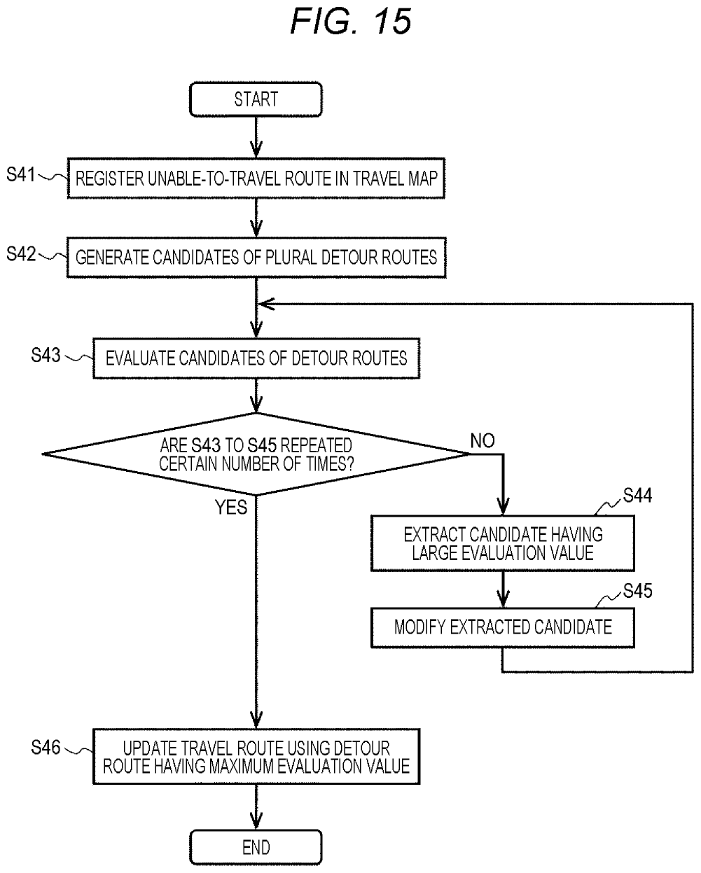

The self-propelled inspection robot 1 according to the sixth embodiment of the invention will be described with reference to FIG. 15. In the following, the self-propelled inspection robot 1 according to this embodiment will be described mainly about the difference from the self-propelled inspection robot 1 according to the first to fifth embodiments.

In the self-propelled inspection robot 1 according to the fifth embodiment, the time compliance evaluation unit 183 evaluates a plurality of candidates of the detour route 6b generated by the route candidate calculation unit 181 using a plurality of evaluation parameters (evaluation value J is obtained). The best candidate (the candidate having the largest evaluation value J) is adopted as the detour route 6b. However, when the evaluation value J of the candidate generated by the route candidate calculation unit 181 is small, even if the candidate having the largest evaluation value J is adopted, the adopted detour route 6b is not always a preferable route, and there may be a preferable detour route 6b separately. For example, in the route generation method by the route candidate calculation unit 181 illustrated in the fifth embodiment, the arrival order of the inspection locations 4 cannot be changed, but there is a possibility that the evaluation value J can be increased by changing the arrival order of the inspection locations 4.

In this embodiment, candidates for the detour route 6b are obtained including the routes which have not been considered in the fifth embodiment, and the candidate having a larger evaluation value J is adopted as the detour route 6b.

FIG. 15 is a flowchart illustrating the process of the travel route generation unit 18 in a case where the inspection continuity determination unit 13 in this embodiment determines that the self-propelled inspection robot 1 cannot travel on the predetermined travel route 6 due to the presence of the obstacle 9 or the like.

The process from S41 to S43 is the same as the process from S31 to S33 in the fifth embodiment, respectively (FIG. 14).

In S44, the route candidate calculation unit 181 extracts a plurality of candidates having a large evaluation value J from the candidates of the plurality of detour routes 6b generated in S42. The route candidate calculation unit 181 extracts, for example, a plurality of candidates for the detour route 6b in a descending order of the evaluation values J.

In S45, the route candidate calculation unit 181 modifies the extracted candidate for the detour route 6b to generate a new candidate for the detour route 6b. A solution search method such as a genetic algorithm can be used to modify the candidate for the detour route 6b.

The route candidate calculation unit 181 repeats the process from S43 to S45 using the new candidate for the detour route 6b generated in S45. That is, the travel route generation unit 18 repeatedly changes the candidate for the detour route 6b little by little by using, for example, a genetic algorithm.

The travel route generation unit 18 repeats the process from S43 to S45 a predetermined number of times, and then proceeds to S46.

In S46, the travel route generation unit 18 adopts the candidate of the detour route 6b having the maximum evaluation value J obtained in S43 as the detour route 6b, and updates the travel route 6.

When the travel route generation unit 18 generates a candidate for the detour route 6b (for example, when the route candidate calculation unit 181 modifies the candidate for the detour route 6b in S45), it is possible to change the speed when the self-propelled inspection robot 1 travels the candidate of the detour route 6b. By changing the traveling speed of the self-propelled inspection robot 1, the travel route generation unit 18 changes the estimated inspection execution time so that the difference between the estimated inspection execution time and the specified inspection execution time becomes small, and the degree of compliance with the inspection time can be changed. At this time, the travel route generation unit 18 may set in advance an upper limit of the possible speed for safety and a lower limit of the speed that does not significantly reduce the inspection efficiency, and may change the speed of the self-propelled inspection robot 1 within the range between the upper limit and the lower limit.

The travel route generation unit 18 changes the degree of compliance with the inspection time by changing the speed at which the self-propelled inspection robot 1 travels on the candidate of the detour route 6b so as to obtain the evaluation value J, and updates the predetermined travel route 6 using the candidate of the detour route 6b having the maximum evaluation value J. For example, if the estimated inspection execution time is not in time for the specified inspection execution time, but the difference between the estimated inspection execution time and the specified inspection execution time is small, the traveling speed of the self-propelled inspection robot 1 is changed rapidly to make the estimated inspection execution time advancing, so that the estimated inspection execution time can be in time with the specified inspection execution time. In this way, the self-propelled inspection robot 1 can perform the inspection more efficiently by changing the traveling speed.

As described above, the self-propelled inspection robot 1 according to this embodiment can generate the detour route 6b having a larger evaluation value J even when the evaluation value J of the candidate of the detour route 6b generated by the route candidate calculation unit 181 is small, and can travel on the detour route 6b in line with the user's intention.

Further, the invention is not limited to the above embodiments, and various modifications may be contained. For example, the above-described embodiments of the invention have been described in detail in a clearly understandable way. The invention is not necessarily limited to those having all the described configurations. In addition, some of the configurations of a certain embodiment can be replaced with the configuration of the other embodiment. Further, it is possible to add the configuration of one embodiment to the configuration of another embodiment. In addition, it is possible to delete a part of the configuration of each embodiment and add/replace another configuration.

What is claimed is:

1. A self-propelled inspection robot for inspecting an equipment by traveling on a predetermined travel route, comprising:
a self-position estimation unit that obtains a position of the self-propelled inspection robot;
an obstacle detection unit that detects an obstacle around the self-propelled inspection robot;
an inspection continuity determination unit that determines whether the self-propelled inspection robot can continue the inspection based on a position of the self-propelled inspection robot obtained by at least the self-position estimation unit and information of the obstacle detected by the obstacle detection unit;
a mode selection unit that selects an automatic mode or a manual mode as a travel mode of the self-propelled inspection robot when the inspection continuity determination unit determines that the self-propelled inspection robot cannot continue the inspection;
a control unit that makes the self-propelled inspection robot automatically travel when the inspection continuity determination unit determines that the self-propelled inspection robot can continue the inspection and when the mode selection unit selects the automatic mode, and makes the self-propelled inspection robot travel by a user's operation when the mode selection unit selects the manual mode; and
an input/output unit that inputs a command from the user.

2. The self-propelled inspection robot according to claim 1, wherein
the automatic mode includes a semi-automatic mode, and
in the semi-automatic mode, the self-propelled inspection robot automatically travels on a route designated by the user.

3. The self-propelled inspection robot according to claim 1, comprising:
a travel route generation unit that generates a travel route of the self-propelled inspection robot when the mode selection unit selects the automatic mode, wherein
the automatic mode includes at least one of an automatic avoidance mode, an automatic detour mode, an automatic evacuation mode, and an automatic standby mode,
in the automatic avoidance mode, the self-propelled inspection robot travels on an avoidance route generated by the travel route generation unit,
in the automatic detour mode, the self-propelled inspection robot travels on a detour route generated by the travel route generation unit,
in the automatic evacuation mode, the self-propelled inspection robot travels on an evacuation route generated by the travel route generation unit, moves to an evacuation location determined by the travel route generation unit, and waits,
in the automatic standby mode, the self-propelled inspection robot waits at a current location by a predetermined period of time,
the avoidance route is a route in which the self-propelled inspection robot avoids the obstacle and travels on a road constituting a travel route during traveling,
the detour route is a route in which the self-propelled inspection robot travels by bypassing the obstacle through a road different from the road constituting the travel route during traveling, and
the evacuation route is a route in which the self-propelled inspection robot travels to the evacuation location which is a location for temporary waiting.

4. The self-propelled inspection robot according to claim 2, comprising:
a travel route generation unit that generates a travel route of the self-propelled inspection robot when the mode selection unit selects the automatic mode, wherein
the automatic mode includes at least one of an avoidance route designation mode, a detour route designation mode, an evacuation location designation mode, and an automatic standby mode, and the avoidance route designation mode, the detour route designation mode, and the evacuation location designation mode are the semi-automatic mode,
in the avoidance route designation mode, the self-propelled inspection robot travels on an avoidance route designated by the user,
in the detour route designation mode, the self-propelled inspection robot travels on a detour route designated by the user,
in the evacuation location designation mode, the self-propelled inspection robot travels on an evacuation route generated by the travel route generation unit, moves to the evacuation location designated by the user and waits,
in the automatic standby mode, the self-propelled inspection robot waits at a current location for a predetermined period of time or a time designated by the user,
the avoidance route is a route in which the self-propelled inspection robot avoids the obstacle and travels on a road constituting the travel route during traveling,
the detour route is a route in which the self-propelled inspection robot travels by bypassing the obstacle through a road different from the road constituting the travel route during traveling, and
the evacuation route is a route in which the self-propelled inspection robot travels to the evacuation location which is a location for temporary waiting.

5. The self-propelled inspection robot according to claim 1, wherein
the mode selection unit selects the automatic mode or the manual mode based on at least one of a position and a size of the obstacle, an operating situation of the equipment included in the self-propelled inspection robot, and a user's instruction.

6. The self-propelled inspection robot according to claim 3, wherein
the travel route generation unit includes a route candidate calculation unit and a time compliance evaluation unit,
the route candidate calculation unit generates one or a plurality of candidates of the detour route when the travel route generation unit generates the detour route, and
the time compliance evaluation unit evaluates a degree of compliance with an inspection time, which is an index indicating a difference between an estimated inspection execution time and a specified inspection execution time which is a predetermined inspection execution time, for the candidates of the detour route generated by the route candidate calculation unit.

7. The self-propelled inspection robot according to claim 6, wherein
the time compliance evaluation unit evaluates a candidate of the detour route using at least one of information regarding execution of the inspection and a mileage of the self-propelled inspection robot, and a degree of compliance with the inspection time as evaluation parameters.

8. The self-propelled inspection robot according to claim 7, wherein
the travel route generation unit updates the predetermined travel route by using a candidate of the detour route having a maximum evaluation value obtained by the time compliance evaluation unit using the evaluation parameters.

9. The self-propelled inspection robot according to claim 8, wherein
the travel route generation unit obtains the evaluation value by changing a speed at which the self-propelled inspection robot travels on a candidate of the detour route, and uses the candidates of the detour route having the maximum evaluation value to update the predetermined travel route.

10. The self-propelled inspection robot according to claim 7, wherein
the input/output unit inputs the evaluation parameter and displays an evaluation value obtained by the time compliance evaluation unit using the evaluation parameter.
